(19) United States
(12) Patent Application Publication
(10) Pub. No.: US 2001/0026507 A1
(43) Pub. Date: Oct. 4, 2001

(54) Control apparatus for optical pickup and optical disc apparatus

(75) Inventor: Koji Fujiyama, Kashiba-shi (JP)

Correspondence Address: DARBY & DARBY, PROFESSIONAL CORPORATION, 805 THIRD AVENUE, NEW YORK, NY, 10022-7513, US

(73) Assignee: SANYO ELECTRIC CO., LTD., OSAKA (JP)

(21) Appl. No.: 09/821,434

(22) Filed: Mar. 28, 2001

(30) Foreign Application Priority Data
Mar. 29, 2000 (JP) 2000-092168

(51) Int. Cl. G11B 7/00

(52) U.S. Cl. 369/44.29

(57) ABSTRACT

An optical disc apparatus for writing data on an optical disc 11 and/or reading data from the optical disc 11 by performing seek control for moving an optical pickup 15 to a target track on the optical disc 11 and focus servo of the optical pickup 15 according to a detected focus error signal and a first transfer function. This optical disc apparatus is provided with a memory 17a for holding a second transfer function different from the first transfer function, and executes the focus servo according to the first transfer function when the seek control is not performed or executes the focus servo according to the second transfer function when the seek control is performed. It is therefore possible to reduce the gain of a focus servo system without lowering the stability, for elimination of noise generated during the seek control.

### BACKGROUND OF THE INVENTION

The present invention relates to an optical disc apparatus for recording and/or reproducing information (only recording information, only reproducing information, or both recording and reproducing information) on an optical disc such as a compact disc, DVD (Digital Versatile Disc) or mini disc, and more particularly relates to an optical disc apparatus capable of eliminating noise generated during a seek operation, and relates to a control apparatus for an optical pickup used in such optical disc apparatus.

FIG. 1 is an explanatory illustration for explaining the operations of focus servo, tracking servo and seek control of an optical pickup.

As illustrated in FIG. 1, the operations of the optical pickup of the optical disc apparatus include a minor operation (indicated by an arrow A) implemented by tracking servo for causing an actuator located at an upper portion 15a of the optical pickup to follow a track on the optical disc; a minor operation (indicated by an arrow B) implemented by focus servo for causing a laser 15c and an actuator of an optical system such as a lens to follow a plane movement of an optical disc surface in a vertical direction; and a major operation (indicated by an arrow C) implemented by seek control (sled control) for moving the whole optical pickup to a target track by a feed motor (not shown) located at a lower portion 15b of the optical pickup.

FIGS. 2A-2D, FIGS. 3A-3E and FIGS. 4A-4E are waveform charts showing the operations of a conventional optical disc apparatus. During the disc control operation for recording or reproducing information on an optical disc, the focus servo shown in FIG. 2A and the tracking servo shown in FIG. 2C are performed based on the focus error signal and the tracking error signal shown in FIGS. 2B and 2D, respectively.

During the seek control (sled control) shown in FIG. 3E, the focus servo shown in FIG. 3A is performed based on the focus error signal shown in FIG. 3B, but the tracking servo shown in FIG. 3C is not executed. At this time, a tracking servo system is supplied with a tracking error signal in the form of a large sine wave shown in FIG. 3D which is generated as the optical pickup crosses the tracks.

Ideally, the above-described focus servo and tracking servo of the optical pickup do not affect each other because their control directions cross each other at right angles.

In actual, however, since their control directions do not cross each other perfectly at right angles, they affect each other, and consequently a problem arises that the focus error signal shown in FIG. 4B of the focus servo of FIG. 4A is affected by the tracking error signal in the form of a large sine wave shown in FIG. 4D and noise is generated during the seek control (sled control) shown in FIG. 4E. Therefore, for example, in the case where a recording type optical disc is used for recording audio information as a recording medium of a digital still camera capable of recording a moving image, the above-mentioned noise is recorded.

In order to solve such a problem, the tracking error signal components (sine wave components) need to be removed from the affected focus error signal. Although the simplest method is implemented by inserting a low-pass filter having a suitable cut-off frequency into the focus servo system, the insertion of the low-pass filter causes a phase lag and lowers the stability (lowers the phase margin), and thus it is hard to say that this method is appropriate.

With reference to the Bode diagrams showing an example of the frequency characteristics of the open loop transfer function of the focus servo system of the conventional optical disc apparatus shown in FIGS. 5A and 5B, this method is evaluated as follows, based on the frequency characteristics of the open loop transfer function of the focus servo system. The insertion of a low-pass filter as mentioned above corresponds to a reduction of the gain by lowering the gain crossover frequency (zero-cross frequency) at which the gain crosses the 0 dB line in the gain curve of the Bode diagram shown in FIG. 5A, thereby increasing the attenuation band indicated by the slanting lines and improving the noise limiting ability. For example, Japanese Patent Application Laid-Open No. 6-150346 (1994) discloses “Method for reducing noise in a disk drive system” based on this concept.

For instance, as shown in FIGS. 5A and 5B, when the gain crossover frequency is 2.3 kHz and the phase margin that is the difference between the phase at that frequency and a phase of −180 degrees is 40 degrees (indicated by the broken line), if the gain is reduced (shown by the solid line) by lowering the gain crossover frequency to 750 Hz, the phase curve does not change, but the phase margin is lowered to 31 degrees. It has been considered from experience that a preferred phase margin for achieving sufficient stability is between 40 and 60 degrees. Thus, it is hard to say that the phase margin after the reduction of the gain is sufficient, and the stability is lowered (the phase margin is lowered) as mentioned above.

### BRIEF SUMMARY OF THE INVENTION

The present invention was invented in view of the above-mentioned circumstance, and an object of the present invention is to provide a control apparatus for optical pickup and an optical disc apparatus which are capable of reducing the gain of a focus servo system without lowering the stability, for elimination of noise generated during seek control.

A control apparatus for optical pickup and an optical disc apparatus comprising it according to the present invention have a transfer function as the transfer functions of the focus servo system for seeking and a transfer function for non-seeking which is different from the transfer function for seeking. In comparison with the transfer function for non-seeking, the transfer function for seeking gives a lower gain crossover frequency (zero-cross frequency) under conditions where the phase margin and DC gain are maintained as same as possible.

FIG. 6 is a schematic diagram for explaining the control operations of the control apparatus for optical pickup according to the present invention. In the optical disc apparatus of the present invention, as shown in the schematic diagram of FIG. 6, the transfer function is switched in seeking and non-seeking between the transfer function for seeking and the transfer function for non-seeking, and the focus servo system performs the focus servo according to the switched transfer function.

A control apparatus for optical pickup according to the present invention is a control apparatus for optical pickup for writing data on an optical disc and/or reading data from the optical disc, comprising: controlling means for performing seek control for moving the optical pickup to a target track on the optical disc and focus servo control of the optical pickup according to a detected focus error signal and a transfer function; and transfer function holding means for holding a first transfer function for executing focus servo when the controlling means does not perform the seek control and a second transfer function for executing focus servo when the controlling means performs the seek control.

In the control apparatus for optical pickup of the present invention, writing data on the optical disc and/or reading data from the optical disc are executed by performing the seek control for moving the optical pickup to a target track on the optical disc and the focus servo of the optical pickup according to a detected focus error signal and the first transfer function by the controlling means. The transfer function holding means holds the first transfer function and the second transfer function different from the first transfer function, and the controlling means executes the focus servo according to the first transfer function when the seek control is not performed or executes the focus servo according to the second transfer function when the seek control is performed.

It is therefore possible to reduce the gain of the focus servo system without lowering the stability, for elimination of noise generated during the seek control.

Moreover, in the control apparatus for optical pickup according to the present invention, the second transfer function has a smaller gain than the first transfer function and a phase margin capable of providing substantially the same stability as that obtained by the first transfer function.

In this control apparatus for optical pickup, since the second transfer function has a smaller gain than the first transfer function and a phase margin capable of providing substantially the same stability as that obtained by the first transfer function, it is possible to reduce the gain of the focus servo system without lowering the stability, for elimination of noise generated during the seek control.

An optical disc apparatus according to the present invention comprises: an optical pickup for writing data on an optical disc and/or reading data from the optical disc; controlling means for performing seek control for moving the optical pickup to a target track on the optical disc and focus servo control of the optical pickup according to a detected focus error signal and a transfer function; and transfer function holding means for holding a first transfer function for executing focus servo when the controlling means does not perform the seek control and a second transfer function for executing focus servo when the controlling means performs the seek control.

In the optical disc apparatus of the present invention, writing data on the optical disc and/or reading data from the optical disc are executed by performing the seek control for moving the optical pickup to a target track on the optical disc and the focus servo of the optical pickup according to a detected focus error signal and the first transfer function by the controlling means. The transfer function holding means holds the first transfer function and the second transfer function different from the first transfer function, and the controlling means executes the focus servo according to the first transfer function when the seek control is not performed or executes the focus servo according to the second transfer function when the seek control is performed.

It is therefore possible to reduce the gain of the focus servo system without lowering the stability, for elimination of noise generated during the seek control.

Moreover, in the optical disc apparatus according to the present invention, the second transfer function has a smaller gain than the first transfer function and a phase margin capable of providing substantially the same stability as that obtained by the first transfer function.

In this optical disc apparatus, since the second transfer function has a smaller gain than the first transfer function and a phase margin capable of providing substantially the same stability as that obtained by the first transfer function, it is possible to reduce the gain of the focus servo system without lowering the stability, for elimination of noise generated during the seek control.

The above and further objects and features of the invention will more fully be apparent from the following detailed description with accompanying drawings.

### BRIEF DESCRIPTION OF THE SEVERAL VIEWS OF THE DRAWINGS

FIG. 1 is an explanatory illustration for explaining the operations of focus servo, tracking servo and seek control of an optical pickup;

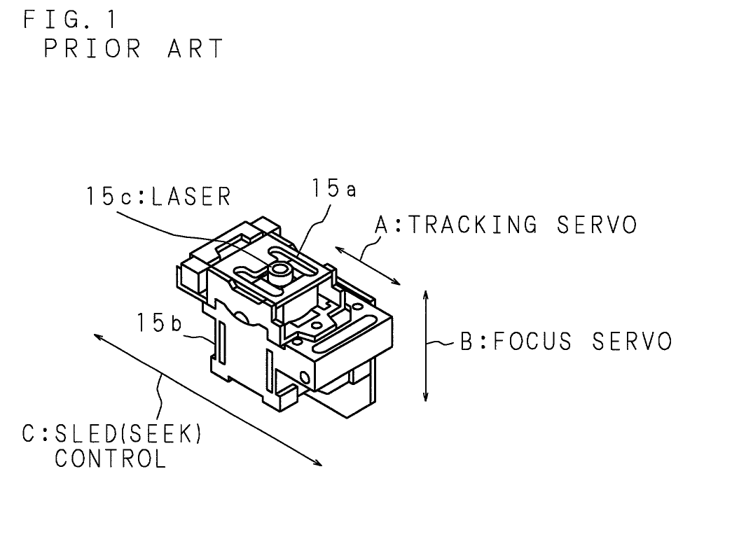

FIGS. 2A-2D are waveform charts showing the operations of a conventional optical disc apparatus;

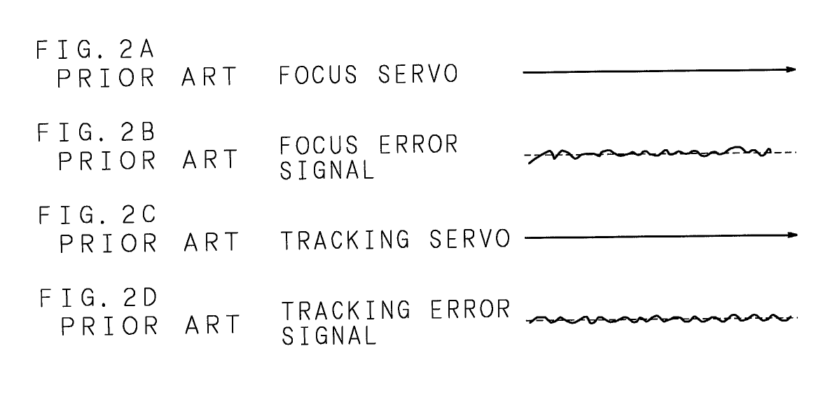

FIGS. 3A-3E are waveform charts showing the operations of the conventional optical disc apparatus;

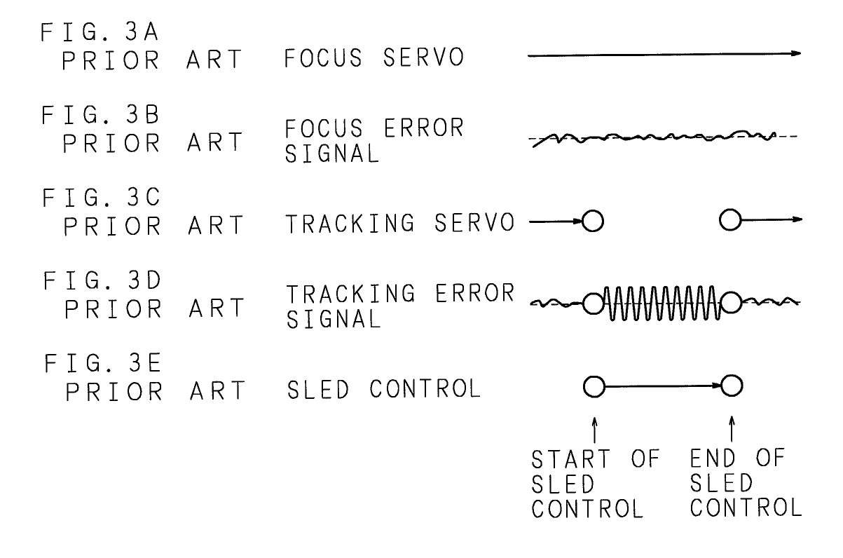

FIGS. 4A-4E are waveform charts showing the operations of the conventional optical disc apparatus;

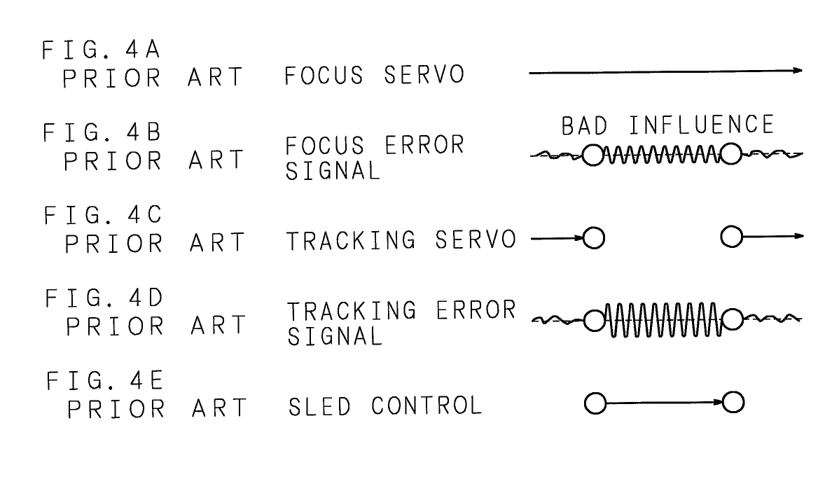

FIGS. 5A and 5B are Bode diagrams showing an example of the frequency characteristics of the open loop transfer function of the focus servo system of the conventional optical disc apparatus;

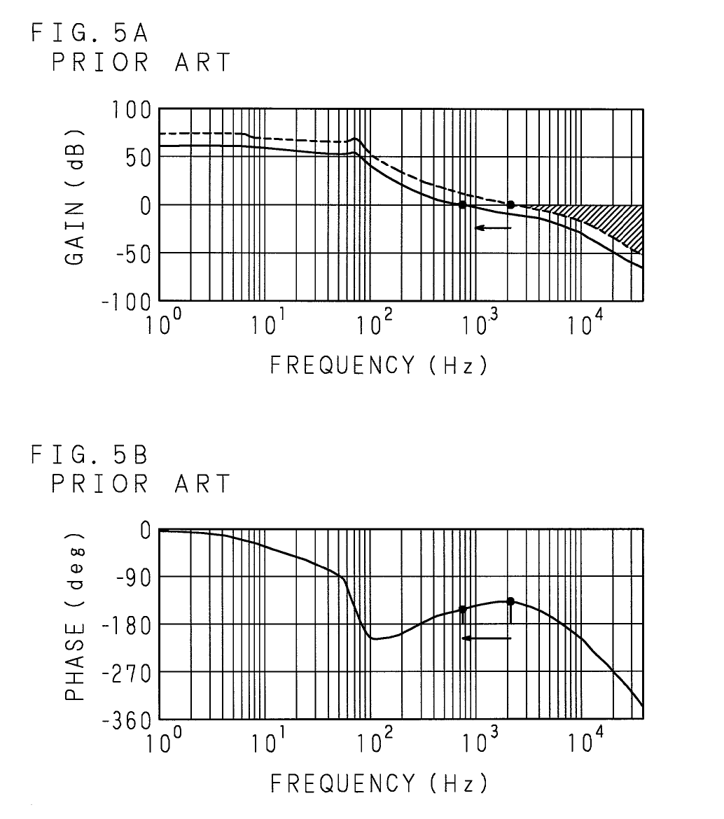

FIG. 6 is a schematic diagram for explaining the operations of a control apparatus for optical pickup and an optical disc apparatus according to the present invention;

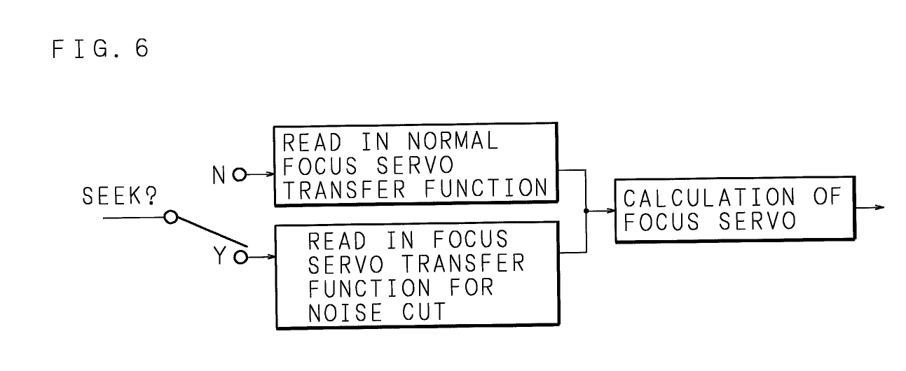

FIG. 7 is a block diagram showing the structure of an embodiment of the control apparatus for optical pickup and optical disc apparatus according to the present invention;

FIG. 8 is a flow chart showing the operations of the control apparatus for optical pickup and optical disc apparatus according to the present invention;

FIG. 9 is a flow chart showing the operations of the control apparatus for optical pickup and optical disc apparatus according to the present invention; and

FIGS. 10A and 10B are Bode diagrams showing an example of the frequency characteristics of the open loop transfer function of the focus servo system of the control apparatus for optical pickup and optical disc apparatus according to the present invention.

### DETAILED DESCRIPTION OF THE INVENTION

The following description will explain the present invention with reference to the drawings illustrating an embodiment thereof.

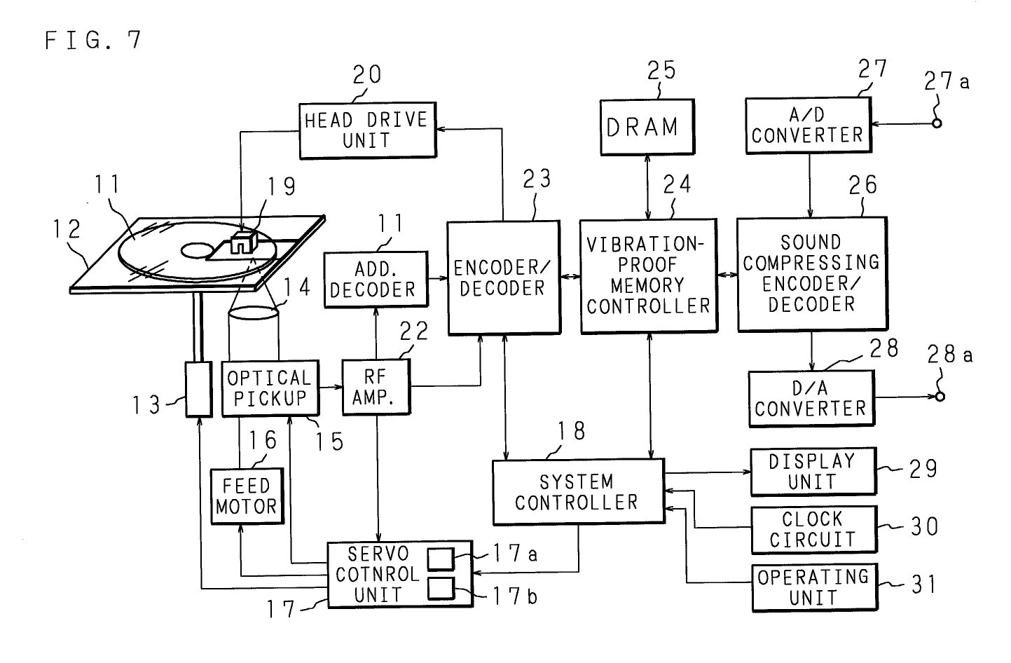

FIG. 7 is a block diagram showing the structure of the embodiment of a control apparatus for optical pickup and an optical disc apparatus according to the present invention. This optical disc apparatus is a mini disc apparatus capable of recording/reproducing information, in which the shutters on both sides of a cartridge 12 in the shape of a square flat plate containing a mini disc 11 are open when the cartridge 12 is loaded in the mini disc apparatus so that an optical pickup 15 reads the information from one of the sides of the mini disc 11 through an objective lens 14 or a magnetic head 19 applies a magnetic field to the other side of the mini disc 11 for recording.

The mini disc 11 is driven by a spindle motor 13 so that it rotates at a predetermined constant linear velocity. The optical pickup 15 is driven by a feed motor 16 and moves in a radial direction of the mini disc 11. In recording, the magnetic head 19 is driven by a head drive unit 20 to move in a radial direction of the mini disc 11 and controlled to come to a position so that it sandwiches a same track with the optical pickup 15 from both sides of the mini disc 11.

The spindle motor 13, optical pickup 15 and feed motor 16 are respectively driven under control by a servo control unit 17.

Signals detected by the optical pickup 15 are sent to a RF (Radio Frequency) amplifier 22 and amplified therein. Among the signals amplified by the RF amplifier 22, a focus error signal and a tracking error signal are sent to the servo control unit 17 and used for the focus servo and tracking servo of the optical pickup 15, and an address signal is sent to an address decoder 21 for decoding and then supplied to an encoder/decoder 23. The servo control unit 17 stores two transfer functions (the first and second transfer functions) for focus servo and a transfer function for tracking servo in an internal memory 17a (transfer function holding means). The servo control unit 17 includes a seek end flag 17b for distinguishing between seeking and non-seeking.

The address signal which has been sent to the encoder/decoder 23 and decoded therein is used for the positioning control of the magnetic head 19 by the head drive unit 20, and also sent to a system controller 18 for use in drive control of the spindle motor 13, optical pickup 15 and feed motor 16 by the servo control unit 17.

Among the signals amplified by the RF amplifier 22, a data signal is sent to the encoder/decoder 23 for decoding and then sent to a DRAM (Dynamic Random Access Memory) 25 through a vibration-proof memory controller 24. The data sent to the DRAM 25 is temporally stored therein, and then sent through the vibration-proof memory controller 24 to a sound compressing encoder/decoder 26 where the data is decoded into the audio data before sound compression and outputted as an analog audio signal from an output terminal 28a through a D/A converter 28.

On the other hand, an analog audio signal inputted from an input terminal 27a is inputted as audio data through an A/D converter 27, encoded by sound compression by the sound compressing encoder/decoder 26, and sent to the DRAM 25 through the vibration-proof memory controller 24. After the data sent to the DRAM 25 is temporality stored in the DRAM 25, it is sent through the vibration-proof memory controller 24 to the encoder/decoder 23 for encoding and then recorded on the mini disc 11 by the magnetic head 19 and optical pickup 15.

The vibration-proof memory controller 24 and DRAM 25 prevent skipping of sound due to vibrations or the like by using the difference between a time required for storing the data in the DRAM 25 and a time required for reading the data from the DRAM 25.

The system controller 18 is connected to a display unit 29, clock circuit 30 and an operating unit 31 so as to control the operations of the servo control unit 17, encoder/decoder 23 and vibration-proof memory controller 24, and also displays specified information on the display unit 29 corresponding to manipulation of the operating unit 31.

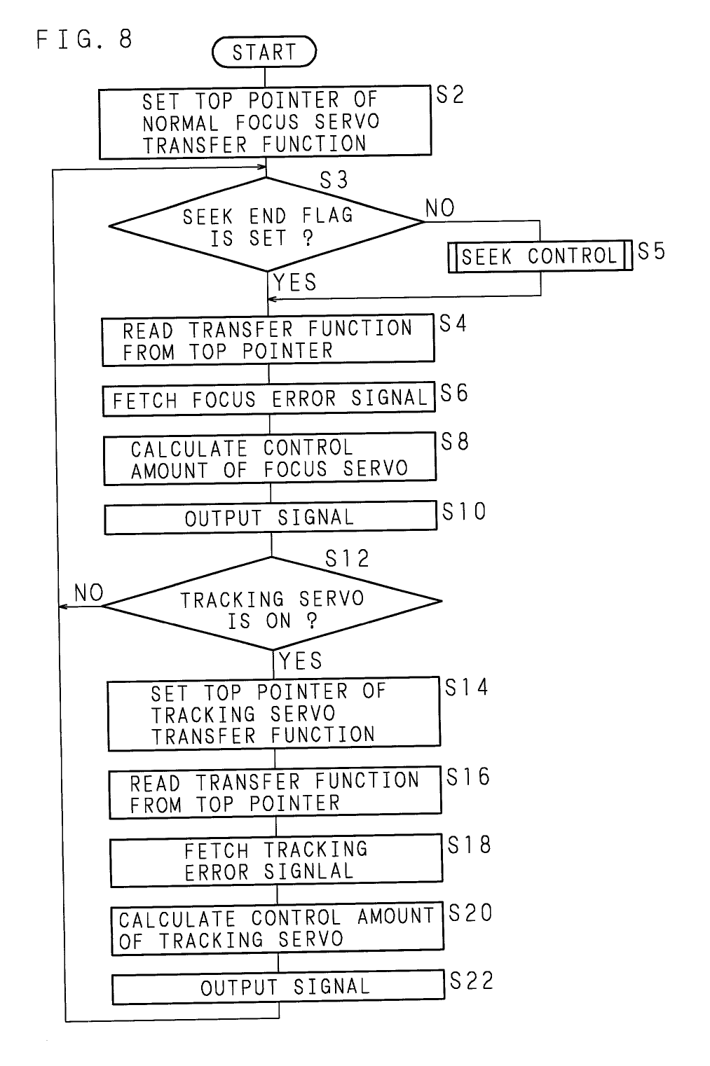

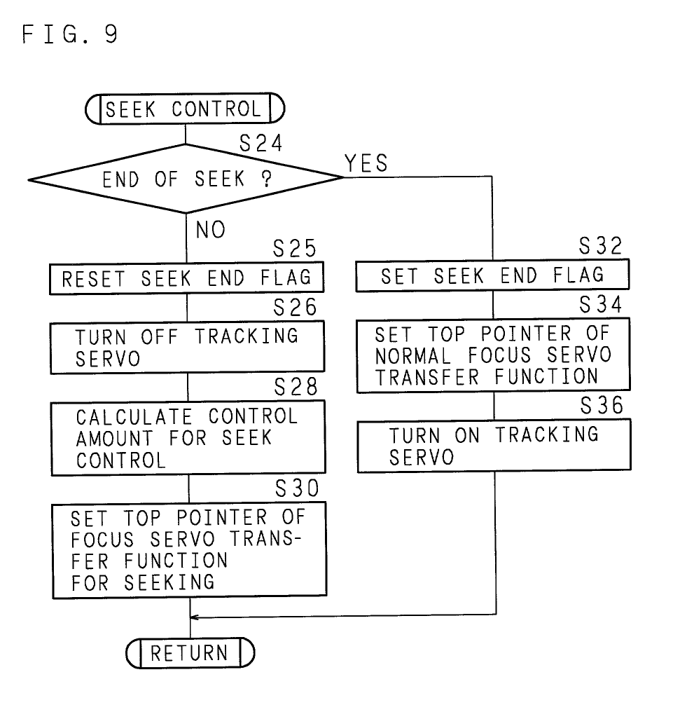

The following description will explain the operation of the mini disc apparatus having such a structure with reference to the flow charts of FIGS. 8 and 9 showing the operation.

In this mini disc apparatus, first, the servo control unit 17 sets the top pointer of a normal focus servo transfer function (the first transfer function) in the memory 17a (step S2), and then judges whether a seek end flag is set or not (step S3). When the seek end flag is set (YES in step S3), the servo control unit 17 reads the transfer function from the top pointer (step S4). When the seek end flag is not set (NO in step S3), the servo control unit 17 performs the processing of seek control (step S5), and then reads the transfer function from the top pointer (step S4).

Next, the servo control unit 17 fetches the focus error signal (step S6), calculates the control amount of focus servo with use of the transfer function read in step S4 (step S8), and outputs a signal representing the calculated control amount of focus servo (step S10).

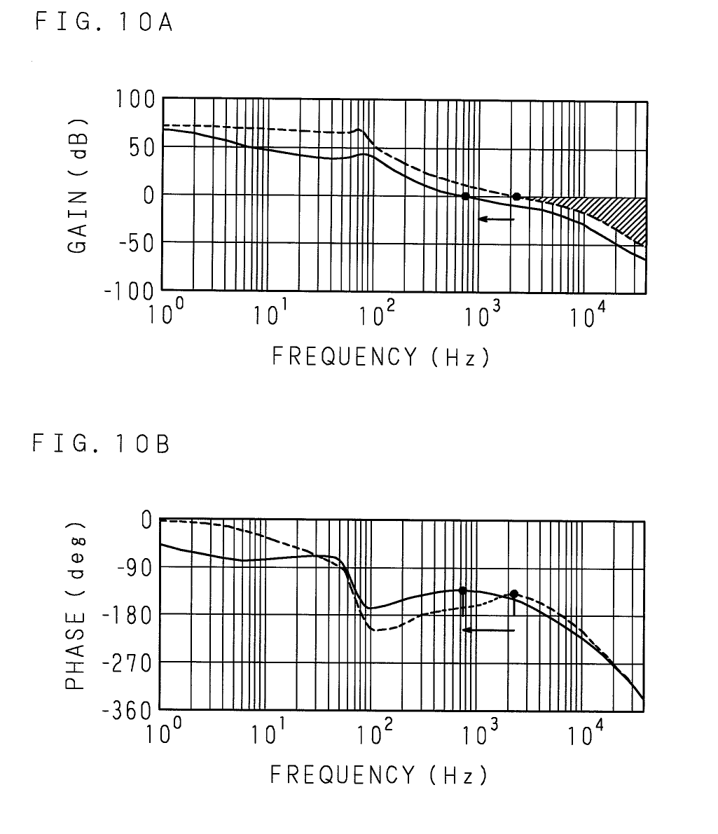

In this case, the transfer function read in step S4 is the normal focus servo transfer function (the first transfer function) and, for example, as indicated by the broken line in the Bode diagrams of FIGS. 10A and 10B, the frequency characteristics show a crossover gain frequency of 2.3 kHz and a phase margin of 40 degrees, thereby achieving a sufficient focus servo response rate.

The focus servo of the optical pickup 15 is performed according to the control amount of focus servo outputted by the servo control unit 17 in step S10.

Next, the servo control unit 17 judges whether the seek end flag is set or not (step S3). When the seek end flag is not set (NO in step S3), the servo control unit 17 performs the processing of seek control (step S5), and then reads the transfer function from the top pointer (step S4) and fetches the focus error signal (step S6).

Subsequently, the servo control unit 17 outputs the calculated control amount of focus servo (step S10), and then judges whether the tracking servo is on or not (step S12). When the tracking servo is not on (NO in step S12), the servo control unit 17 returns the process to step S3 and judges whether the seek end flag is set or not.

When the tracking servo is on (YES in step S12), the servo control unit 17 sets the top pointer of a tracking servo transfer function in the memory 17a (step S14), and then reads the transfer function from the top pointer (step S16).

Next, the servo control unit 17 fetches the tracking error signal (step S18), calculates the control amount of tracking servo with use of the transfer function fetched in step S16 (step S20), outputs a signal representing the calculated control amount of tracking servo (step S22), and returns the process to step S3 so as to judge whether the seek end flag is set or not.

The tracking servo of the optical pickup 15 is performed according to the control amount of tracking servo outputted from the servo control unit 17 in step S22.

The above-mentioned focus servo and tracking servo processes are performed at a predetermined sampling frequency, and will never be suspended except for the occasions where a command is present or the seek control process (step S5) is performed.

The seek control process (step S5) is independent of the above-mentioned focus servo and tracking servo processes, and the servo control unit 17 changes process from the focus servo and tracking servo processes to the seek control process when a command to start seek control is given from the system controller 18 by manipulation of the operating unit 31, etc.

When the servo control unit 17 is given the command to start seek control or changes to the seek control process (step S5 of FIG. 8), when the seek control has not been completed (NO in step S24 of FIG. 9), the servo control unit 17 first resets the seek end flag 17b (step S25) and turns off the tracking servo (step S26).

Next, the servo control unit 17 calculates the control amount for seek control (step S28), sets the top pointer of a focus servo transfer function (the second transfer function) for seeking in the memory 17a (step S30), and returns to step S4 for the focus servo process (FIG. 8) so as to read the transfer function from the top pointer.

Subsequently, the servo control unit 17 fetches the focus error signal (step S6), calculates the control amount of focus servo with use of the transfer function read in step S4 (step S8), and outputs a signal representing the control amount of focus servo calculated in step S8 and a signal representing the control amount of seek control calculated previously in step S28 (step S10).

The focus servo of the optical pickup 15 is performed according to the control amount of focus servo outputted from the servo control unit 17 in step S10, and the feed motor 16 moves the optical pickup 15 according to the control amount of seek control outputted from the servo control unit 17 in step S10.

In this case, the transfer function read in step S4 is the focus servo transfer function (the second transfer function) for seeking and, for example, as indicated by the solid line in the Bode diagrams of FIGS. 10A and 10B, the frequency characteristics show that the gain in the high frequency band is reduced by about 70 dB and the attenuation band is increased by lowering the crossover gain frequency to 750 Hz, and thus the optical pickup 15 is hardly affected by the tracking error signal during seeking, maintains a frequency margin of around 45 degrees and has no problem in the stability.

When the seek control has been completed (YES in step S24 of FIG. 9), the servo control unit 17 sets the seek end flag 17b (step S32), and sets the top pointer of the normal focus servo transfer function (the first transfer function) in the memory 17a (step S34).

Next, the servo control unit 17 turns on the tracking servo (step S36), and returns to step S4 for the focus servo process (FIG. 8) so as to read the transfer function from the top pointer.

Subsequently, the servo control unit 17 fetches the focus error signal (step S6), calculates the control amount of focus servo with use of the transfer function read in step S4 (step S8), and outputs a signal representing the control amount of focus servo calculated in step S8 (step S10).

In this case, the transfer function read in step S4 is the normal focus servo transfer function (the first transfer function) and, for example, as indicated by the broken line in the Bode diagrams of FIGS. 10A and 10B, the frequency characteristics show a crossover gain frequency of 2.3 kHz and a phase margin of 40 degrees, thereby achieving a sufficient focus servo response rate.

As described above, as indicated by the broken line in the Bode diagrams of FIGS. 10A and 10B, when the frequency characteristics of an open loop transfer function for non-seeking show a crossover gain frequency of 2.3 kHz and a phase margin of 40 degrees, when the frequency characteristics of an open loop transfer function for seeking are arranged to have a crossover gain frequency of 750 Hz, a phase margin of 45 degrees and a gain reduction of 70 dB, the gain in the high frequency band is reduced and the attenuation band is increased as indicated by the solid line in FIGS. 10A and 10B.

Consequently, the optical pickup 15 is hardly affected by the tracking error signal during seeking, and since the phase margin is maintained around 45 degrees, there is no problem in the stability. However, with this open loop transfer function for seeking, the response rate of focus servo is not sufficient, and therefore switching of the transfer functions is performed during non-seeking to use the transfer function for non-seeking.

According to the control apparatus for optical pickup and the optical disc apparatus of the present invention, it is possible to reduce the gain of the focus servo system without lowering the stability, for elimination of noise generated during seek control.

As this invention may be implemented in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A control apparatus for an optical pickup for writing data on an optical disc and/or reading data from the optical disc, comprising:
controlling means for performing seek control for moving said optical pickup to a target track on the optical disc and focus servo control of said optical pickup according to a detected focus error signal and a transfer function; and
transfer function holding means for holding a first transfer function for executing focus servo when said controlling means does not perform said seek control, and a second transfer function for executing focus servo when said controlling means performs said seek control.

2. The control apparatus for optical pickup as set forth in claim 1, wherein
said second transfer function has a smaller gain than said first transfer function and a phase margin capable of providing substantially same stability as that obtained by said first transfer function.

3. An optical disc apparatus comprising:
an optical pickup for writing data on an optical disc and/or reading data from the optical disc;
controlling means for performing seek control for moving said optical pickup to a target track on the optical disc and focus servo control of said optical pickup according to a detected focus error signal and a transfer function; and
transfer function holding means for holding a first transfer function for executing focus servo when said controlling means does not perform said seek control, and a second transfer function for executing focus servo when said controlling means performs said seek control.

4. The optical disc apparatus as set forth in claim 3, wherein
said second transfer function has a smaller gain than said first transfer function and a phase margin capable of providing substantially same stability as that obtained by said first transfer function.
